(19) United States
(12) Patent Application Publication
(10) Pub. No.: US 2026/0255158 A1
(43) Pub. Date: Aug. 27, 2026

(54) SECURE ELECTROMAGNETIC COMMUNICATION USING MULTI FREQUENCY SIGNAL CHANNELS

(71) Applicant: Harold Owens, III, Indianapolis, IN (US)

(72) Inventor: Harold Owens, III, Indianapolis, IN (US)

(21) Appl. No.: 19/545,656

(22) Filed: Feb. 20, 2026

Related U.S. Application Data
(60) Provisional application No. 63/761,204, filed on Feb. 21, 2025.

(51) Int. Cl. H04W 12/033; H04B 10/50; H04B 17/21; H04W 12/0431

(52) U.S. Cl. CPC H04W 12/033; H04B 10/503; H04B 17/21; H04W 12/0431

(57) ABSTRACT

A secure electromagnetic communication system and method are provided. Input data is encrypted using a symmetric key encryption algorithm to generate encrypted data. The encrypted data is divided into uncorrelated data streams. Each data stream is converted into a corresponding control sequence that controls the operation of a respective electromagnetic signal generator. Electromagnetic signal generators emit electromagnetic radiation within distinct frequency ranges according to the control sequences. Electromagnetic signal detectors receive the emitted electromagnetic radiation within distinct frequency ranges. Outputs of the electromagnetic signal detectors are processed and decrypted to recover the input data. The system supports multi-channel signal states, calibration of signal detectors, and insertion of non-data-carrying signal states to improve the security and robustness of communication.

### CROSS-REFERENCE TO RELATED APPLICATION

This application claims the benefit of priority to U.S. Provisional Patent Application No. 63/761,204, filed on 02/21/2025, the entire contents of which are hereby incorporated by reference for all purposes.

### TECHNICAL FIELD

The present invention relates generally to secure communication systems, and more particularly to systems and methods for encrypting and transmitting data using multiple electromagnetic signal channels operating at distinct frequency ranges.

### BACKGROUND

Secure communication systems play a critical role in protecting information transmitted across wired and wireless channels. Conventional secure communication techniques primarily rely on mathematical cryptographic algorithms executed at higher protocol layers to protect data confidentiality and integrity. These techniques typically assume that the underlying physical communication channel is either trusted or adequately abstracted from the encryption process. As a result, transmitted signals often remain observable, measurable, and susceptible to interception even when the payload content is encrypted.

Existing communication systems commonly transmit encrypted data over a single carrier frequency or a narrow frequency band using standardized modulation schemes. Although encryption prevents direct interpretation of intercepted data, an adversary may still analyze signal characteristics such as timing, power levels, frequency usage, and modulation patterns. Such side channel information can assist traffic analysis, enable replay attacks, or reduce the effective security margin of cryptographic systems. Moreover, concentration of encrypted data onto a single channel creates a single point of interception and increases vulnerability to jamming, interference, and selective disruption.

To address these concerns, some prior approaches employ frequency hopping, spread spectrum techniques, or multi input multi output systems. Frequency hopping systems vary carrier frequencies over time to reduce predictability, while spread spectrum techniques distribute signal energy across a wider bandwidth to improve resistance to interference. Multi input multi output systems transmit multiple spatial streams in parallel to increase throughput and reliability. While these techniques improve robustness and spectral efficiency, they typically remain agnostic to the encryption process and do not inherently divide encrypted information into uncorrelated portions tied to distinct physical signal channels. Consequently, an intercepted signal may still contain sufficient information to facilitate analysis or targeted attacks.

Other approaches attempt to integrate encryption with modulation by embedding cryptographic transformations directly into symbol mapping or modulation parameters. These solutions often increase system complexity, impose strict synchronization requirements, or depend on specialized hardware configurations that limit scalability. In addition, many such approaches rely on a single electromagnetic domain or a fixed set of modulation parameters, which restricts adaptability across different operating environments and frequency ranges.

One example of relevant prior art is U.S. Patent No. 9,628,459 B2, titled “Secure data transmission using multi-channel communication.” This reference discloses techniques in which message data is transmitted across more than one communication channel to improve security and reliability of transmission. The system distributes message information across multiple communication paths and reconstructs the message at a receiving device. Although this reference recognizes the use of multiple channels to enhance secure data transfer, it primarily focuses on distributing message data across available communication channels and does not disclose generating distinct electromagnetic signal states defined by channel weights or controlling separate electromagnetic emitters operating in distinct frequency ranges as part of a coordinated physical layer encryption architecture. The reference also does not describe duration-based multi-channel emission control or detector threshold calibration as provided by the present invention.

Another example of relevant prior art is U.S. Patent Application Publication No. US 2020/0356684, titled “Method and Apparatus for Multi-Channel Secure Communication and Data Transfer.” This reference describes techniques for transmitting data securely using multiple communication channels and coordinated transmission processes between a transmitting device and a receiving device. The publication teaches use of multiple channels for secure data transfer and coordinated processing of transmitted information. However, the disclosed approach primarily addresses secure data transfer across communication channels at a system or network level and does not disclose or suggest a secure electromagnetic communication system that divides encrypted data into uncorrelated data streams and transmits the data streams using a plurality of electromagnetic signal generators operating in distinct frequency ranges with control sequences derived from channel weight mappings. The reference therefore leaves a need for an integrated architecture that combines encryption with physically distinct electromagnetic emission channels and detector-based reconstruction.

Accordingly, there exists a need for a secure communication architecture that more tightly integrates cryptographic processing with the physical transmission layer while remaining flexible, scalable, and compatible with diverse electromagnetic signaling technologies. There remains further scope for systems that distribute encrypted information across multiple uncorrelated data streams and transmit those data streams using physically distinct electromagnetic frequency ranges.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only and is not intended to limit the scope of the present disclosure.

The present invention provides a secure electromagnetic communication system, method, and non transitory computer readable medium that enable transmission of encrypted data using multiple electromagnetic signal channels operating at distinct frequency ranges. The invention improves security, robustness, and resistance to interception by distributing encrypted information across uncorrelated data streams and transmitting the data streams using physically distinct electromagnetic emissions.

In an embodiment, the invention provides a secure electromagnetic communication system that includes at least one processor and a non transitory memory storing instructions executable by the at least one processor. The at least one processor encrypts input data using a symmetric key encryption algorithm to generate encrypted data and splits the encrypted data into a plurality of uncorrelated data streams. The system further includes a plurality of electromagnetic signal generators. Each electromagnetic signal generator emits electromagnetic radiation within a respective frequency range that differs from frequency ranges of remaining electromagnetic signal generators. Drive circuitry controls each electromagnetic signal generator according to a respective control sequence derived from a corresponding data stream.

The system further includes a plurality of electromagnetic signal detectors. Each electromagnetic signal detector detects electromagnetic radiation within a respective one of the distinct frequency ranges. A reconstruction module processes outputs of the plurality of electromagnetic signal detectors and decrypts the processed outputs using the symmetric key encryption algorithm to recover the input data.

In another embodiment, the invention provides a method for secure electromagnetic communication. The method includes encrypting input data using a symmetric key encryption algorithm to generate encrypted data, splitting the encrypted data into a plurality of uncorrelated data streams, and generating a respective control sequence for each data stream. The method further includes transmitting the data streams by driving a plurality of electromagnetic signal generators according to the respective control sequences within distinct frequency ranges, detecting the transmitted electromagnetic radiation using a plurality of electromagnetic signal detectors corresponding to the distinct frequency ranges, and decrypting information derived from detector outputs to recover the input data.

In yet another embodiment, the invention provides a non transitory computer readable medium storing instructions that, when executed by at least one processor, cause the at least one processor to perform encryption of input data, generation of uncorrelated data streams, control of electromagnetic signal generators operating in distinct frequency ranges, processing of electromagnetic signal detector outputs, and decryption to recover the input data.

In certain implementations, the system maps bits of a data stream to multi channel signal states defined by channel weights that control emission characteristics of the electromagnetic signal generators. In some implementations, the system inserts non data carrying signal states as decoys to increase resistance to unauthorized interception. In further implementations, the system performs calibration of the electromagnetic signal detectors by transmitting known signal combinations and establishing detection thresholds based on detector responses

These and other features and advantages of the present invention will become apparent from the detailed description below, in light of the accompanying drawings.

### BRIEF DESCRIPTION OF THE DRAWINGS

FIG. 1 illustrates a general implementation environment of a secure electromagnetic communication system, in accordance with an exemplary embodiment of the present invention;

FIG. 2 illustrates a block diagram of a transmitter portion of the secure electromagnetic communication system of FIG. 1, in accordance with an exemplary embodiment of the present invention;

FIG. 3 illustrates a block diagram of a receiver portion of the secure electromagnetic communication system of FIG. 1, according to one embodiment of the present invention;

FIG. 4 illustrates an example arrangement of the plurality of electromagnetic signal generators and the plurality of electromagnetic signal detectors, according to one embodiment of the present invention;

FIG. 5 illustrates an example mapping between encrypted data and multi channel signal states defined by channel weights used to generate control sequences for the plurality of electromagnetic signal generators, according to one embodiment of the present invention;

FIG. 6 illustrates an example timing diagram showing duration based control of electromagnetic signal generators during a bit period in accordance with a control sequence, according to one embodiment of the present invention;

FIG. 7 illustrates an example calibration process in which known signal combinations are transmitted by the plurality of electromagnetic signal generators and detection thresholds are established for the plurality of electromagnetic signal detectors, in accordance with one embodiment of the present invention;

FIG. 8 illustrates a flow diagram of a method for secure electromagnetic communication, according to one embodiment of the present invention;

FIG. 9 illustrates an example of non-data carrying signal states inserted into an encrypted transmission to increase resistance to unauthorized interception, according to one embodiment of the present invention;

FIG. 10 illustrates an example array based implementation in which multiple electromagnetic signal generators and electromagnetic signal detectors operate in parallel to transmit encrypted data blocks, according to one embodiment of the present invention;

FIG. 11 illustrates example implementations of the secure electromagnetic communication system across different portions of the electromagnetic spectrum, according to one embodiment of the present invention; and

FIG. 12 illustrates an example implementation of a non-transitory computer readable medium storing instructions that control operation of the secure electromagnetic communication system, in accordance with one embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a secure electromagnetic communication system. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Further, the words “user” and “person” are used interchangeably in the description.

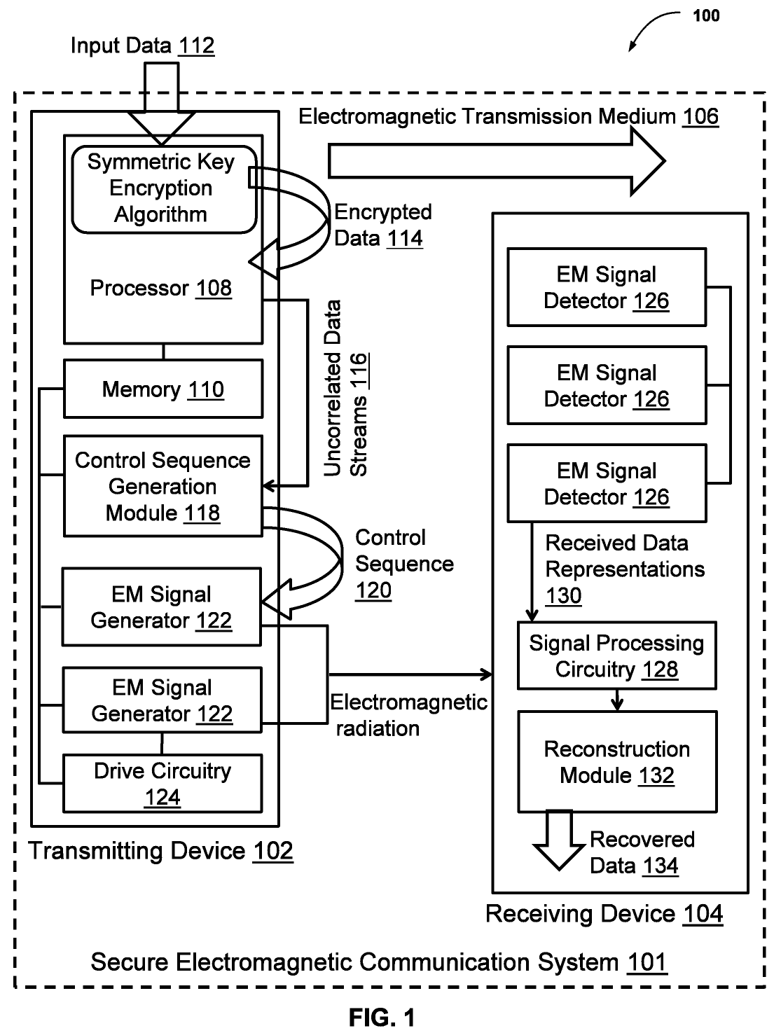

A secure electromagnetic communication system will now be described with reference to the accompanying drawings, particularly FIGS. 1-12.

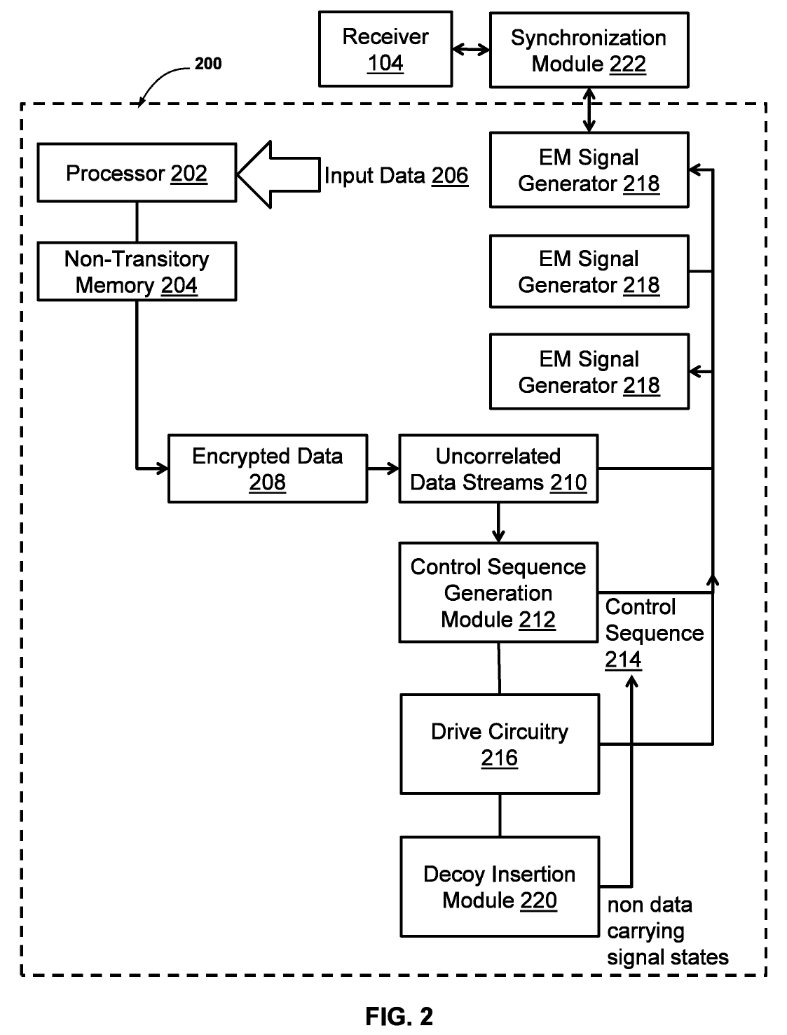

Referring to FIG. 1 in conjunction with FIGS. 2–11 illustrates a general implementation environment 100 of a secure electromagnetic communication system 101 in accordance with the present invention. The secure electromagnetic communication system 101 supports transmission of encrypted data using multiple electromagnetic signal channels operating at distinct frequency ranges.

The secure electromagnetic communication system 101 includes a transmitting device 102 and a receiving device 104 that communicate through an electromagnetic transmission medium 106. In one embodiment, the electromagnetic transmission medium 106 comprises free space. In other embodiments, the electromagnetic transmission medium 106 comprises at least one guided medium, including an optical waveguide or a shielded electromagnetic conduit.

The transmitting device 102 includes at least one processor 108 and a non-transitory memory 110. The non transitory memory 110 stores instructions that, when executed by the at least one processor 108, cause the at least one processor 108 to encrypt input data 112 using a symmetric key encryption algorithm to generate encrypted data 114. The at least one processor 108 further splits the encrypted data into a plurality of uncorrelated data streams 116.

The transmitting device 102 further includes a control sequence generation module 118. The control sequence generation module 118 generates a respective control sequence 120 for each data stream of the plurality of uncorrelated data streams 116. Each control sequence defines how a corresponding electromagnetic signal generator 122 operates over time.

The transmitting device 102 further includes a plurality of electromagnetic signal generators 122. Each electromagnetic signal generator 122 emits electromagnetic radiation within a respective frequency range that differs from the frequency ranges of the remaining electromagnetic signal generators 122. In one embodiment, the plurality of electromagnetic signal generators 122 includes light-emitting diodes configured to emit visible or infrared light. In another embodiment, the plurality of electromagnetic signal generators 122 includes radio frequency oscillators. In further embodiments, the plurality of electromagnetic signal generators 122 includes a combination of optical and radio frequency emitters.

Further, the transmitting device 102 includes a drive circuitry 124 that electrically couples the control sequence generation module 118 to the plurality of electromagnetic signal generators 122. The drive circuitry 124 controls activation timing, intensity, or duration of emission of each electromagnetic signal generator 122 according to the respective control sequence 120. In one example, the drive circuitry 124 controls the duration of emission during a bit period to encode data values.

Electromagnetic radiation emitted by the plurality of electromagnetic signal generators 122 propagates through the electromagnetic transmission medium 106 toward the receiving device 104. The receiving device 104 includes a plurality of electromagnetic signal detectors 126. Each electromagnetic signal detector 126 detects electromagnetic radiation within a respective one of the distinct frequency ranges associated with the plurality of electromagnetic signal generators 122.

In one embodiment, the plurality of electromagnetic signal detectors 126 includes photodiodes configured to detect optical radiation. In another embodiment, the plurality of electromagnetic signal detectors 126 includes radio frequency receivers. In further embodiments, the plurality of electromagnetic signal detectors 126 includes a combination of optical and radio frequency detectors.

The receiving device 104 further includes signal processing circuitry 128 that processes outputs of the plurality of electromagnetic signal detectors 126 to generate received data representations 130 corresponding to the plurality of uncorrelated data streams 116. The receiving device 104 further includes a reconstruction module 132 that decrypts the received data representations 130 using the symmetric key encryption algorithm to recover the input data 134 corresponding to the input data 112.

In certain embodiments, the secure electromagnetic communication system 101 inserts non data carrying signal states into the plurality of uncorrelated data streams 116 to increase resistance to unauthorized interception. In other embodiments, the secure electromagnetic communication system 101 performs a calibration operation by transmitting known signal combinations and adjusting detection thresholds of the plurality of electromagnetic signal detectors 126 based on detector responses. FIG. 1 represents a functional overview of the secure electromagnetic communication system 101. Other figures further illustrate detailed structures, control mechanisms, and operational methods consistent with the system illustrated in FIG. 1.

FIG. 2 illustrates a transmitter architecture 200 of the secure electromagnetic communication system 101 shown in FIG. 1. The transmitter architecture 200 forms part of the transmitting device 102 and generates electromagnetic signals that carry encrypted data across distinct frequency ranges. The transmitter architecture 200 includes at least one processor 202 and a non-transitory memory 204. The non transitory memory 204 stores program instructions that, when executed by the at least one processor 202, cause the at least one processor 202 to perform encryption, data stream partitioning, and control sequence generation operations consistent with the claims.

The at least one processor 202 receives input data 206 from a data source. In one embodiment, the data source comprises a computing device, a sensor system, or a network interface. In another embodiment, the data source comprises stored data retrieved from local memory or a remote system. The at least one processor 202 encrypts the input data 206 using a symmetric key encryption algorithm to generate encrypted data 208.

The at least one processor 202 divides the encrypted data 208 into a plurality of uncorrelated data streams 210. Each data stream of the plurality of uncorrelated data streams 210 carries a portion of the encrypted data 208 such that no single data stream independently represents the encrypted data 208. In one example, the at least one processor 202 performs a weighted distribution of encrypted bits across the plurality of uncorrelated data streams 210.

The transmitter architecture 200 further includes a control sequence generation module 212. The control sequence generation module 212 generates a respective control sequence 214 for each data stream of the plurality of uncorrelated data streams 210. Each control sequence 214 specifies emission parameters for a corresponding electromagnetic signal generator.

In one embodiment, the control sequence generation module 212 maps bits of a data stream to multi-channel signal states defined by channel weights. Each channel weight controls emission behaviour of a corresponding electromagnetic signal generator during a bit period. In one example, a triplet of integer channel weights defines duration of emission for three electromagnetic signal generators.

The transmitter architecture 200 further includes drive circuitry 216. The drive circuitry 216 electrically couples the control sequence generation module 212 to a plurality of electromagnetic signal generators 218. The drive circuitry 216 controls timing, duration, and intensity of electromagnetic radiation emitted by each electromagnetic signal generator 218 according to the respective control sequence 214.

Each electromagnetic signal generator 218 emits electromagnetic radiation within a respective frequency range that differs from the frequency ranges of the remaining electromagnetic signal generators 218. In one embodiment, the plurality of electromagnetic signal generators 218 includes light-emitting diodes configured to emit visible or infrared radiation. In another embodiment, the plurality of electromagnetic signal generators 218 includes radio frequency oscillators configured to emit radio frequency signals. In further embodiments, the plurality of electromagnetic signal generators 218 includes combinations of optical and radio frequency emitters.

In certain embodiments, the transmitter architecture 200 includes an optional decoy insertion module 220. The decoy insertion module 220 inserts non data carrying signal states into the control sequences 214. The decoy insertion module 220 increases resistance to signal analysis by unauthorized receivers.

In further embodiments, the transmitter architecture 200 includes a synchronization module 222. The synchronization module 222 establishes timing alignment between the transmitter architecture 200 and the receiving device 104. In one example, the synchronization module 222 embeds synchronization markers within the control sequences 214.

Electromagnetic radiation generated by the plurality of electromagnetic signal generators 218 exits the transmitting device 102 and propagates through the electromagnetic transmission medium 106 toward the receiving device 104. FIG. 2 illustrates functional components of the transmitter architecture 200. Other embodiments may combine or separate components while remaining consistent with the transmitter architecture 200 and the claims.

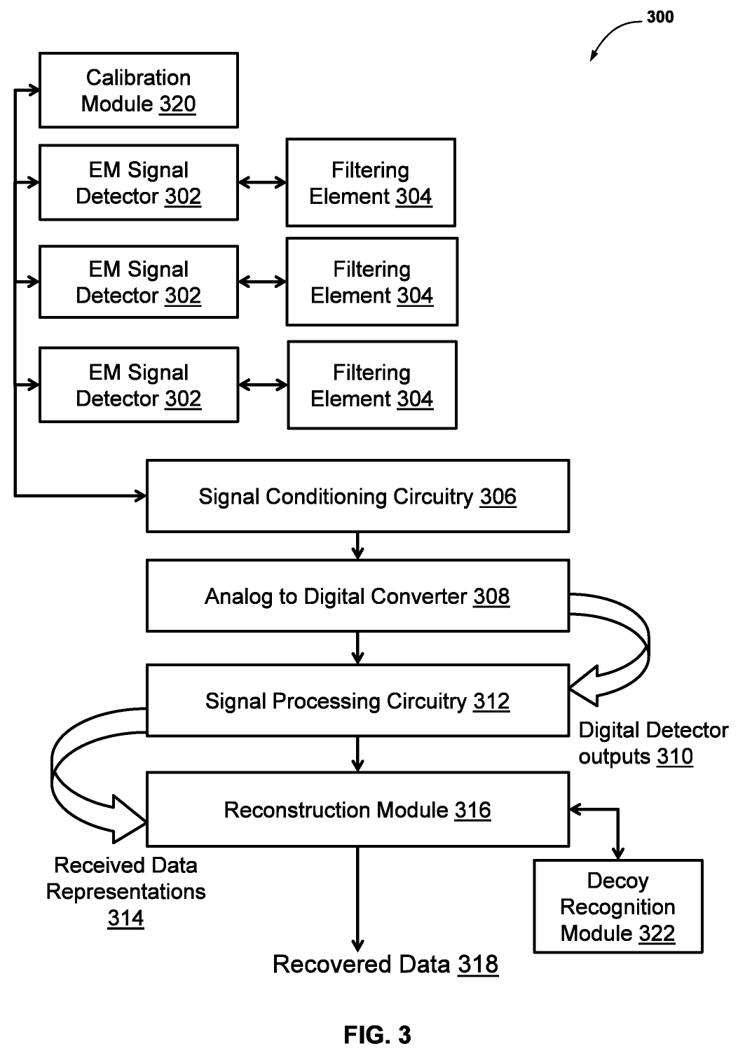

FIG. 3 illustrates a receiver architecture 300 of the secure electromagnetic communication system 101 shown in FIG. 1. The receiver architecture 300 forms part of the receiving device 104 and receives electromagnetic radiation transmitted by the transmitting device 102 across distinct frequency ranges.

The receiver architecture 300 includes a plurality of electromagnetic signal detectors 302. Each electromagnetic signal detector 302 detects electromagnetic radiation within a respective frequency range that corresponds to a frequency range used by a corresponding electromagnetic signal generator 218 of the transmitter architecture 200. The plurality of electromagnetic signal detectors 302 provide separate detection paths so that each detected signal represents a portion of transmitted encrypted data.

In one embodiment, the plurality of electromagnetic signal detectors 302 includes photodiodes configured to detect visible or infrared radiation. In another embodiment, the plurality of electromagnetic signal detectors 302 includes radio frequency receivers configured to detect radio frequency emissions. In further embodiments, the plurality of electromagnetic signal detectors 302 includes a combination of optical detectors and radio frequency receivers to support operation across multiple portions of the electromagnetic spectrum.

The receiver architecture 300 further includes optional filtering elements 304 associated with respective electromagnetic signal detectors 302. Each filtering element 304 limits received electromagnetic radiation to the respective frequency range assigned to the associated electromagnetic signal detector 302. In one example, a filtering element 304 includes an optical band pass filter positioned in front of a photodiode. In another example, a filtering element 304 includes an electronic band limiting circuit coupled to a radio frequency receiver.

Outputs of the plurality of electromagnetic signal detectors 302 couple to signal conditioning circuitry 306. The signal conditioning circuitry 306 amplifies, shapes, and stabilizes detector outputs to produce conditioned signals suitable for digital processing. In one embodiment, the signal conditioning circuitry 306 includes amplification stages and noise reduction components.

The receiver architecture 300 further includes at least one analog to digital converter 308. The at least one analog to digital converter 308 converts conditioned analog signals into digital detector outputs 310. Each digital detector output 310 corresponds to a respective one of the distinct frequency ranges.

The receiver architecture 300 further includes signal processing circuitry 312. The signal processing circuitry 312 analyzes the digital detector outputs 310 to generate received data representations 314 corresponding to the plurality of uncorrelated data streams 210 generated by the transmitter architecture 200. In one embodiment, the signal processing circuitry 312 determines timing, duration, or intensity characteristics of detected signals to identify multi-channel signal states.

The receiver architecture 300 further includes a reconstruction module 316. The reconstruction module 316 combines the received data representations 314 and decrypts the combined information using the symmetric key encryption algorithm to generate recovered data 318 corresponding to the input data 206. The reconstruction module 316 uses knowledge of channel assignments and control sequence formats to correctly reassemble the plurality of uncorrelated data streams 210.

In certain embodiments, the receiver architecture 300 includes a calibration module 320. The calibration module 320 processes detector responses to known signal combinations transmitted by the transmitting device 102 and establishes detection thresholds for each electromagnetic signal detector 302. The calibration module 320 improves reliability of detection under varying environmental conditions.

In further embodiments, the receiver architecture 300 includes a decoy recognition module 322. The decoy recognition module 322 identifies predefined non data carrying signal states and excludes those signal states from reconstruction operations. The receiver architecture 300 may also include a synchronization module (not shown). The synchronization module detects synchronization markers embedded within received signals and aligns timing for processing of the digital detector outputs 310.

FIG. 3 illustrates functional components of the receiver architecture 300 that cooperate to detect electromagnetic radiation across distinct frequency ranges, generate received data representations 314, and recover decrypted data 318. Other embodiments may combine, reorder, or distribute the described components across multiple devices while remaining consistent with the receiver architecture 300 and the claims.

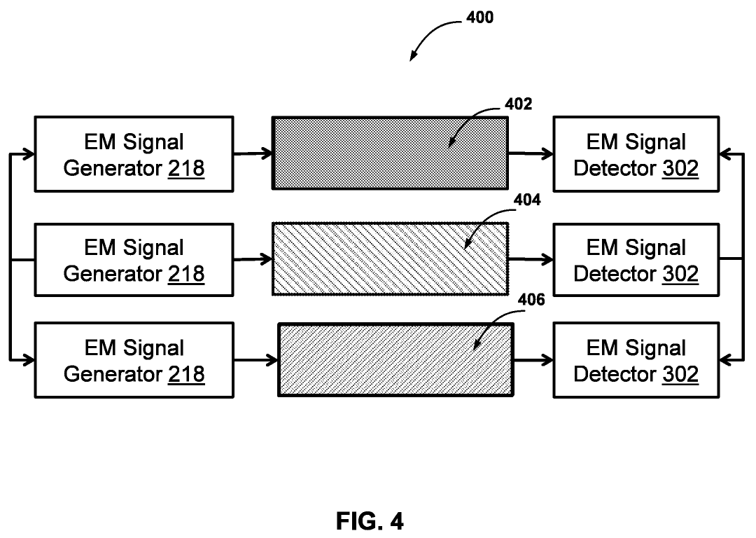

FIG. 4 illustrates an example frequency domain arrangement 400 of the secure electromagnetic communication system 101 shown in FIG. 1. The frequency domain arrangement 400 shows how the transmitting device 102 and the receiving device 104 operate using multiple electromagnetic signal channels that occupy distinct frequency ranges.

The frequency domain arrangement 400 includes a first frequency range 402, a second frequency range 404, and a third frequency range 406. Each frequency range corresponds to a respective electromagnetic signal generator 218 of the transmitter architecture 200 and to a corresponding electromagnetic signal detector 302 of the receiver architecture 300. The distinct frequency ranges reduce overlap between transmitted signals and allow the receiver architecture 300 to separate detected signals into independent detection paths.

In the illustrated embodiment, the first frequency range 402 represents a lower frequency band, the second frequency range 404 represents an intermediate frequency band, and the third frequency range 406 represents a higher frequency band. The secure electromagnetic communication system 101 assigns each data stream of the plurality of uncorrelated data streams 210 to a respective one of the distinct frequency ranges 402, 404, and 406.

The transmitting device 102 drives a first electromagnetic signal generator 218 to emit electromagnetic radiation within the first frequency range 402 according to a first control sequence 214. The transmitting device 102 drives a second electromagnetic signal generator 218 to emit electromagnetic radiation within the second frequency range 404 according to a second control sequence 214. The transmitting device 102 drives a third electromagnetic signal generator 218 to emit electromagnetic radiation within the third frequency range 406 according to a third control sequence 214. Each control sequence 214 encodes information derived from a corresponding one of the plurality of uncorrelated data streams 210.

The receiving device 104 positions a first electromagnetic signal detector 302 to detect electromagnetic radiation within the first frequency range 402, a second electromagnetic signal detector 302 to detect electromagnetic radiation within the second frequency range 404, and a third electromagnetic signal detector 302 to detect electromagnetic radiation within the third frequency range 406. Optional filtering elements 304 associated with each electromagnetic signal detector 302 limit received electromagnetic radiation to the respective assigned frequency range.

In one embodiment, the first frequency range 402, the second frequency range 404, and the third frequency range 406 lie within the visible or infrared portion of the electromagnetic spectrum. In this embodiment, the electromagnetic signal generators 218 include light emitting diodes that emit different wavelengths, and the electromagnetic signal detectors 302 include photodiodes paired with optical filters.

In another embodiment, the first frequency range 402, the second frequency range 404, and the third frequency range 406 lie within the radio frequency portion of the electromagnetic spectrum. In this embodiment, the electromagnetic signal generators 218 include voltage-controlled oscillators, and the electromagnetic signal detectors 302 include radio frequency receivers with band limiting circuitry.

In further embodiments, the secure electromagnetic communication system 101 selects frequency ranges from different portions of the electromagnetic spectrum to increase separation between channels. For example, the transmitting device 102 may assign one data stream to an optical frequency range and another data stream to a radio frequency range.

The frequency domain arrangement 400 supports mapping of multi-channel signal states defined by channel weights to the distinct frequency ranges 402, 404, and 406. The transmitter architecture 200 varies emission duration or intensity within each frequency range according to the respective control sequence 214. The receiver architecture 300 detects the resulting signals and reconstructs received data representations 314 for each data stream.

FIG. 4 demonstrates that distribution of encrypted data across distinct frequency ranges reduces the information content available from any single frequency range and increases resistance to interception, interference, and selective jamming. Other embodiments may include more than three frequency ranges or may dynamically adjust frequency assignments while remaining consistent with the frequency domain arrangement 400 and the claims.

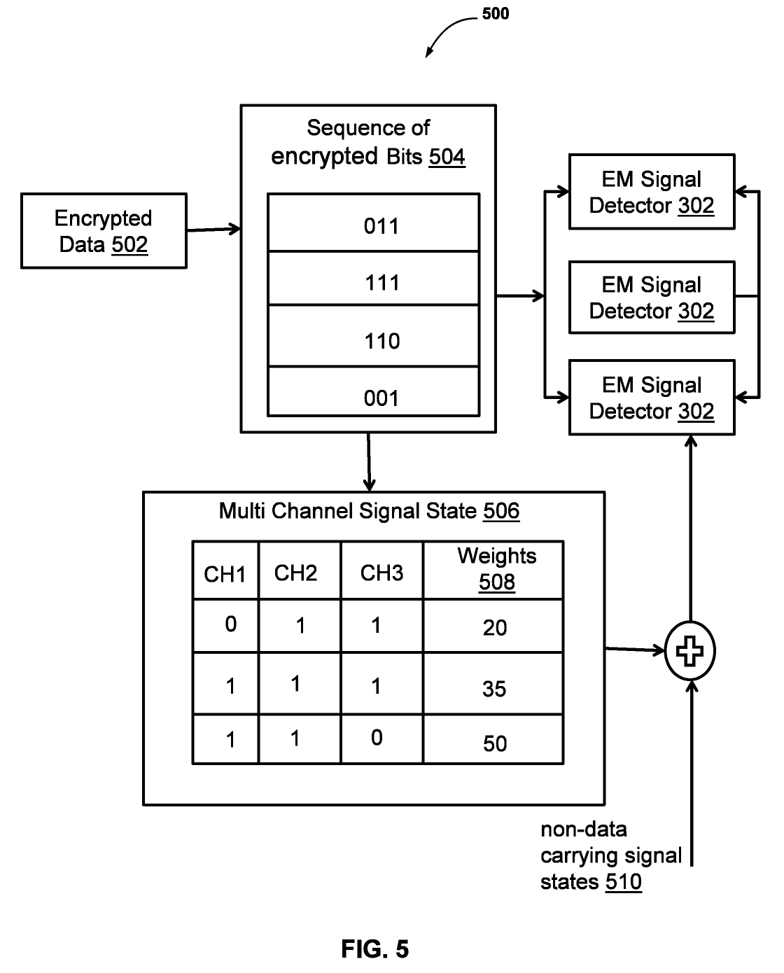

FIG. 5 illustrates an example mapping arrangement 500 between encrypted data and multi-channel signal states used by the secure electromagnetic communication system 101 shown in FIG. 1. The mapping arrangement 500 shows how the transmitter architecture 200 converts encrypted data into channel weights that define control sequences for the plurality of electromagnetic signal generators 218.

The mapping arrangement 500 includes encrypted data 502 generated by the at least one processor 202 after encryption of the input data 206 using the symmetric key encryption algorithm. The encrypted data 502 includes a sequence of encrypted bits 504. The transmitter architecture 200 partitions the encrypted bits 504 into the plurality of uncorrelated data streams 210 as described with reference to FIG. 2.

The control sequence generation module 212 converts each encrypted bit 504, or group of encrypted bits 504, into a corresponding multi-channel signal state 506. Each multi-channel signal state 506 includes a set of channel weights 508. The channel weights 508 define emission behavior of the plurality of electromagnetic signal generators 218 during a defined bit period.

In one embodiment, the multi-channel signal state 506 includes a triplet of channel weights 508 associated with a first electromagnetic signal generator 218, a second electromagnetic signal generator 218, and a third electromagnetic signal generator 218. Each channel weight 508 specifies a duration for which the corresponding electromagnetic signal generator 218 remains in a HIGH emission state during the bit period. For example, a first multi-channel signal state 506 representing a logical value may include channel weights 508 of three units, one unit, and two units for the respective electromagnetic signal generators 218.

In another embodiment, the channel weights 508 specify relative intensity levels rather than durations. In this embodiment, the drive circuitry 216 controls emission intensity of each electromagnetic signal generator 218 according to the channel weights 508 while maintaining a constant bit period.

In further embodiments, the control sequence generation module 212 assigns multi-channel signal states 506 based on a lookup table stored in the non-transitory memory 204. The lookup table associates candidate multi-channel signal states 506 with encrypted bit values. The at least one processor 202 selects the mapping based on a symmetric key so that an unauthorized receiver cannot determine the association between the encrypted bits 504 and the multi-channel signal states 506.

The mapping arrangement 500 may also include predefined non-data carrying signal states 510. The control sequence generation module 212 inserts the non-data carrying signal states 510 into the sequence of multi-channel signal states 506 to act as decoys. The decoy insertion module 220 selects positions of the non-data carrying signal states 510 according to a pattern derived from the symmetric key.

Each multi-channel signal state 506 produces a corresponding control sequence 214 that drives the plurality of electromagnetic signal generators 218 within their respective distinct frequency ranges. The drive circuitry 216 activates each electromagnetic signal generator 218 according to the channel weights 508 so that the emitted electromagnetic radiation represents the multi-channel signal state 506.

The receiver architecture 300 detects electromagnetic radiation from the plurality of electromagnetic signal generators 218 using the plurality of electromagnetic signal detectors 302. The signal processing circuitry 312 determines the observed multi-channel signal state from detected timing or intensity characteristics and generates the received data representations 314. The reconstruction module 316 uses knowledge of the mapping arrangement 500 and the symmetric key encryption algorithm to reconstruct the encrypted data 502 and recover the input data 318.

FIG. 5 demonstrates that the mapping arrangement 500 distributes information for each encrypted bit across multiple electromagnetic signal channels through the channel weights 508. This distribution reduces the ability of an interceptor to derive useful information from any single detected channel. Other embodiments may use more than three electromagnetic signal generators 218, may vary the number of channel weights 508 per multi-channel signal state 506, or may dynamically update mapping rules while remaining consistent with the mapping arrangement 500 and the claims.

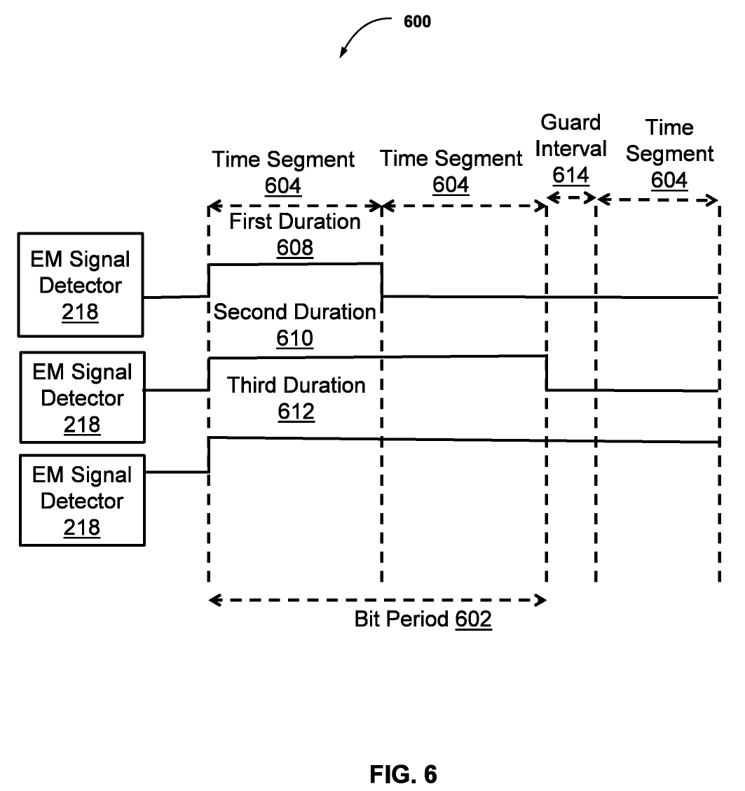

FIG. 6 illustrates an example timing arrangement 600 that shows duration-based control of the plurality of electromagnetic signal generators 218 during a bit period in accordance with a control sequence 214 generated by the transmitter architecture 200. The timing arrangement 600 demonstrates how the secure electromagnetic communication system 101 encodes information by controlling emission duration within distinct frequency ranges.

The timing arrangement 600 includes a bit period 602 that defines a fixed time interval assigned to represent one data unit derived from the plurality of uncorrelated data streams 210. The transmitter architecture 200 divides the bit period 602 into a plurality of time segments 604. Each time segment 604 corresponds to a potential emission interval for a respective electromagnetic signal generator 218.

The control sequence 214 specifies channel weights 606 associated with the plurality of electromagnetic signal generators 218. Each channel weight 606 defines a duration during which a corresponding electromagnetic signal generator 218 remains in a HIGH emission state within the bit period 602. In some embodiments, channel weights define time-varying frequency characteristics within a bit period, including linear or non-linear frequency sweeps. The drive circuitry 216 activates each electromagnetic signal generator 218 according to the respective channel weight 606.

In one embodiment, a first electromagnetic signal generator 218 emits electromagnetic radiation for a first duration 608 within the bit period 602, a second electromagnetic signal generator 218 emits electromagnetic radiation for a second duration 610, and a third electromagnetic signal generator 218 emits electromagnetic radiation for a third duration 612. The combination of the first duration 608, the second duration 610, and the third duration 612 forms a multi-channel signal state 506 that represents a value derived from the encrypted data 208.

The timing arrangement 600 may maintain a constant total bit period 602 while varying individual durations assigned to the plurality of electromagnetic signal generators 218. In this manner, the transmitter architecture 200 encodes information without changing overall transmission rate. In another embodiment, the transmitter architecture 200 varies both duration and relative start times of emission intervals to increase the number of available multi-channel signal states 506.

The receiving device 104 detects electromagnetic radiation using the plurality of electromagnetic signal detectors 302. The signal conditioning circuitry 306 and the analog to digital converter 308 generate digital detector outputs 310 that indicate when each electromagnetic signal detector 302 observes electromagnetic radiation. The signal processing circuitry 312 measures observed durations within the bit period 602 and determines the corresponding channel weights 606.

The reconstruction module 316 compares the determined channel weights 606 with expected multi-channel signal states 506 defined by the mapping arrangement 500. The reconstruction module 316 generates the received data representations 314 and decrypts the received data representations 314 using the symmetric key encryption algorithm to recover transmitted data 318.

In certain embodiments, the transmitter architecture 200 inserts guard intervals 614 between time segments 604 to reduce overlap between emissions from different electromagnetic signal generators 218. In other embodiments, the transmitter architecture 200 adjusts the bit period 602 based on channel conditions detected during a calibration operation performed by the calibration module 320.

FIG. 6 demonstrates that duration based control within the bit period 602 allows the secure electromagnetic communication system 101 to encode information across multiple electromagnetic signal channels while maintaining separation between distinct frequency ranges. Other embodiments may employ additional electromagnetic signal generators 218, different time segment resolutions, or adaptive duration assignments while remaining consistent with the timing arrangement 600 and the claims.

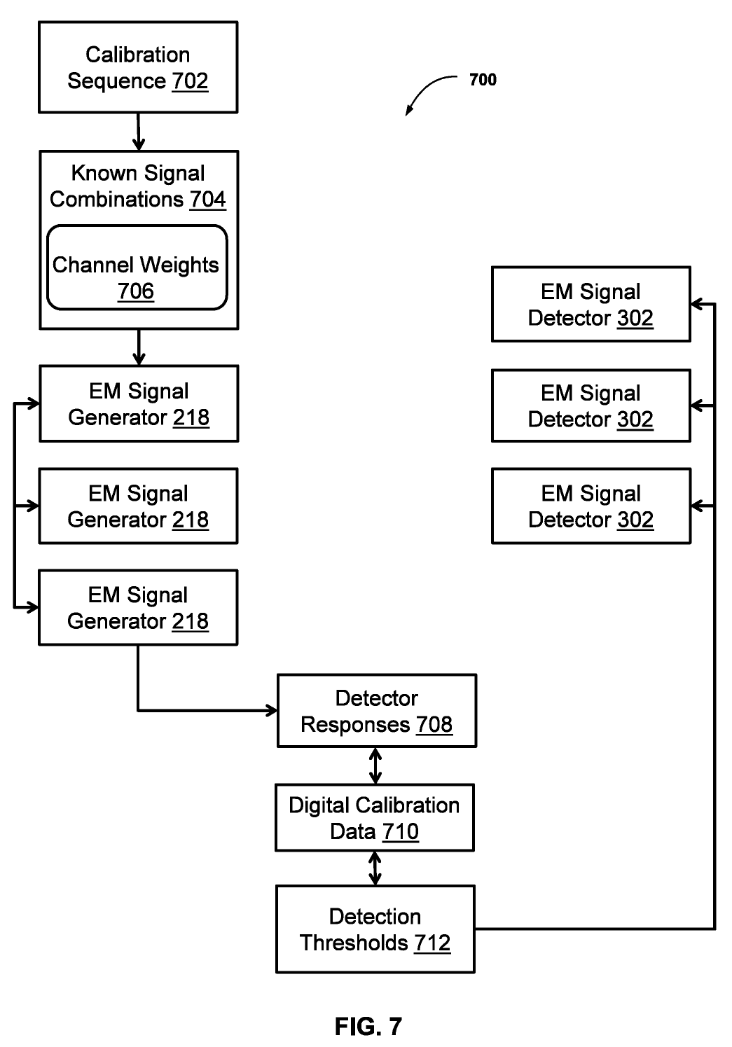

FIG. 7 illustrates a calibration arrangement 700 used by the secure electromagnetic communication system 101 shown in FIG. 1. The calibration arrangement 700 establishes detection thresholds for the plurality of electromagnetic signal detectors 302 based on known signal combinations generated by the transmitter architecture 200. The calibration arrangement 700 improves accuracy of signal detection across the distinct frequency ranges.

The calibration arrangement 700 begins when the transmitting device 102 initiates a calibration sequence 702. During the calibration sequence 702, the control sequence generation module 212 generates a set of known signal combinations 704. Each known signal combination 704 includes predefined channel weights 706 assigned to the plurality of electromagnetic signal generators 218.

The drive circuitry 216 controls the plurality of electromagnetic signal generators 218 according to the known signal combinations 704. Each electromagnetic signal generator 218 emits electromagnetic radiation within its respective frequency range while the calibration sequence 702 remains active. In one embodiment, the calibration sequence 702 transmits individual channel activations in which only one electromagnetic signal generator 218 emits radiation at a time. In another embodiment, the calibration sequence 702 transmits combined channel activations that include multiple electromagnetic signal generators 218 operating simultaneously.

The receiving device 104 receives the transmitted electromagnetic radiation using the plurality of electromagnetic signal detectors 302. Each electromagnetic signal detector 302 produces detector responses 708 corresponding to the known signal combinations 704. The signal conditioning circuitry 306 and the analog to digital converter 308 convert the detector responses 708 into digital calibration data 710.

The receiver architecture 300 includes the calibration module 320. The calibration module 320 analyzes the digital calibration data 710 and determines detection thresholds 712 for each electromagnetic signal detector 302. Each detection threshold 712 represents a boundary that distinguishes between a valid emission state and a non-emission state within the respective frequency range.

In one embodiment, the calibration module 320 determines detection thresholds 712 by measuring average signal levels observed during transmission of the known signal combinations 704 and by setting threshold values above measured noise levels. In another embodiment, the calibration module 320 evaluates multiple signal strength samples and selects threshold values that minimize detection errors across repeated calibration transmissions.

The calibration arrangement 700 may also include storage of calibration parameters in the non-transitory memory of the receiving device 104. The receiver architecture 300 retrieves the calibration parameters during normal communication to interpret detector outputs 310 and to determine channel weights 606 with improved accuracy.

In certain embodiments, the transmitting device 102 repeats the calibration sequence 702 at scheduled intervals to account for environmental changes, component drift, or variation in transmission distance. In other embodiments, the receiver architecture 300 triggers the calibration sequence 702 when detected signal quality falls below a predefined level.

FIG. 7 demonstrates that the calibration arrangement 700 establishes reliable detection thresholds for the plurality of electromagnetic signal detectors 302 using known signal combinations 704. The calibration arrangement 700 enables the receiver architecture 300 to correctly interpret multi-channel signal states 506 and to support accurate reconstruction of the plurality of uncorrelated data streams 210. Other embodiments may employ additional calibration patterns, adaptive threshold updates, or environment specific calibration routines while remaining consistent with the calibration arrangement 700 and the claims.

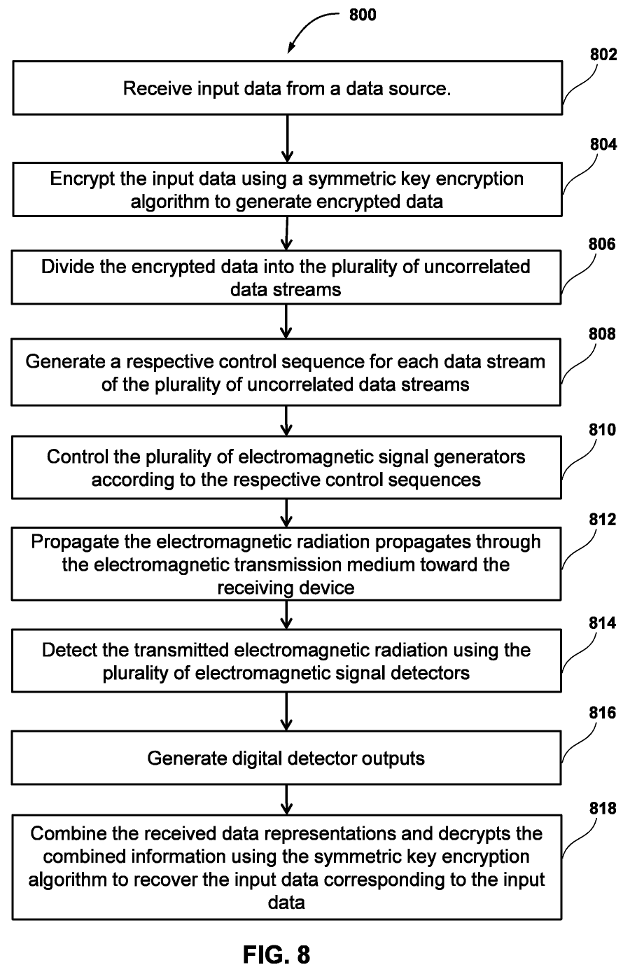

FIG. 8 illustrates a method arrangement 800 for secure electromagnetic communication performed by the secure electromagnetic communication system 101 shown in FIG. 1. The method arrangement 800 describes operational steps executed by the transmitting device 102 and the receiving device 104 to transmit encrypted data using multiple electromagnetic signal channels that operate at distinct frequency ranges.

At step 802, the method includes receiving input data 206 from a data source. The transmitting device 102 receives input data 206 from a data source. In one embodiment, the data source comprises a computing platform that provides digital information for secure transfer. In another embodiment, the data source comprises a sensor system that generates measurement data.

At step 804, the method includes encrypting the input data 206 using a symmetric key encryption algorithm to generate encrypted data 208. The at least one processor 202 encrypts the input data 206 using a symmetric key encryption algorithm to generate encrypted data 208. The symmetric key may originate from a pre shared key, a key distribution procedure, or a secure session establishment process.

At step 806, the method includes dividing the encrypted data 208 into the plurality of uncorrelated data streams 210. In an embodiment, the at least one processor 202 divides the encrypted data 208 into the plurality of uncorrelated data streams 210. Each data stream carries a portion of the encrypted data 208 such that reconstruction requires combination of multiple data streams.

At step 808, the method includes generating a respective control sequence 214 for each data stream of the plurality of uncorrelated data streams 210. The control sequence generation module 212 generates a respective control sequence 214 for each data stream of the plurality of uncorrelated data streams 210. In one embodiment, the control sequence generation module 212 maps encrypted bits to multi-channel signal states 506 defined by channel weights 508.

At step 810, the method includes controlling the plurality of electromagnetic signal generators 218 according to the respective control sequences 214. The drive circuitry 216 controls the plurality of electromagnetic signal generators 218 according to the respective control sequences 214. Each electromagnetic signal generator 218 emits electromagnetic radiation within a respective frequency range that differs from frequency ranges of remaining electromagnetic signal generators 218. In one example, the drive circuitry 216 controls duration of emission within a bit period 602 to represent channel weights 606.

At step 812, the method includes propagating the electromagnetic radiation propagates through the electromagnetic transmission medium 106 toward the receiving device 104. The electromagnetic radiation propagates through the electromagnetic transmission medium 106 toward the receiving device 104. In one embodiment, the electromagnetic transmission medium 106 comprises free space. In another embodiment, the electromagnetic transmission medium 106 comprises an optical or guided path.

At step 814, the method includes detecting the transmitted electromagnetic radiation using the plurality of electromagnetic signal detectors 302. The receiving device 104 detects the transmitted electromagnetic radiation using the plurality of electromagnetic signal detectors 302. Each electromagnetic signal detector 302 detects electromagnetic radiation within a respective one of the distinct frequency ranges.

At step 816, the method includes generating digital detector outputs 310. The signal conditioning circuitry 306 and the analogue-to-digital converter 308 generate digital detector outputs 310. The signal processing circuitry 312 analyzes the digital detector outputs 310 to determine observed multi-channel signal states 506 and to generate received data representations 314 corresponding to the plurality of uncorrelated data streams 210.

At step 818, the method includes combining the received data representations 314 and decrypting the combined information using the symmetric key encryption algorithm to generate recovered data 318 corresponding to the input data 206. The reconstruction module 316 combines the received data representations 314 and decrypts the combined information using the symmetric key encryption algorithm to recover the input data 318 corresponding to the input data 206.

FIG. 8 demonstrates that the method arrangement 800 integrates encryption, distribution of encrypted data into uncorrelated data streams, transmission across distinct frequency ranges, detection of electromagnetic radiation, and decryption to recover decrypted data 318. Other embodiments may reorder certain steps, perform selected steps in parallel, or execute the steps using distributed processing components while remaining consistent with the method arrangement 800 and the claims.

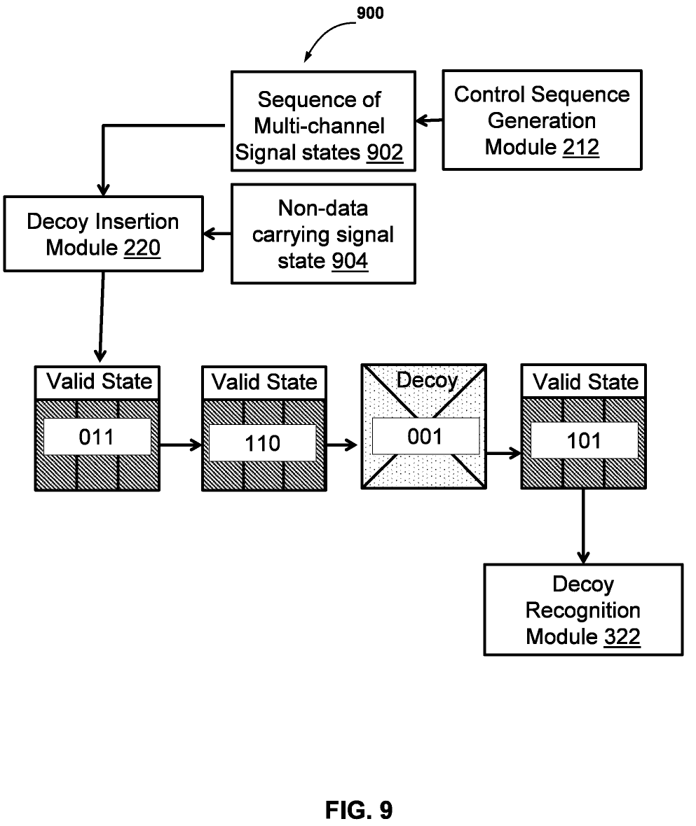

FIG. 9 illustrates a decoy signalling arrangement 900 used by the secure electromagnetic communication system 101 shown in FIG. 1. The decoy signalling arrangement 900 shows insertion of non-data carrying signal states into a sequence of transmitted signals to increase resistance to unauthorized interception and signal analysis.

The decoy signalling arrangement 900 includes a sequence of multi-channel signal states 902 generated by the control sequence generation module 212 based on encrypted data 208. Each multi-channel signal state 902 corresponds to channel weights 508 that control operation of the plurality of electromagnetic signal generators 218 during a respective bit period 602.

The decoy insertion module 220 selects at least one non-data carrying signal state 904 and inserts the non-data carrying signal state 904 into the sequence of multi-channel signal states 902. The non data carrying signal state 904 does not represent a valid encrypted bit value. Instead, the non-data carrying signal state 904 acts as a decoy that obscures the relationship between transmitted electromagnetic emissions and actual encrypted data.

In one embodiment, the non-data carrying signal state 904 includes at least one channel weight 508 set to zero while remaining channel weights 508 define emission durations that do not correspond to any valid mapping stored in the lookup table of the non-transitory memory 204. In another embodiment, the non-data carrying signal state 904 includes channel weights 508 that intentionally violate a predefined duration ratio used for valid multi-channel signal states 506.

The decoy insertion module 220 determines positions for insertion of the non-data carrying signal state 904 according to a pattern derived from the symmetric key encryption algorithm. In one example, the decoy insertion module 220 inserts the non-data carrying signal state 904 after a variable number of valid multi-channel signal states 506. In another example, the decoy insertion module 220 inserts multiple consecutive non data carrying signal states 904 to create uncertainty in timing analysis.

The drive circuitry 216 controls the plurality of electromagnetic signal generators 218 according to the sequence that includes both valid multi-channel signal states 506 and the non-data carrying signal state 904. Each electromagnetic signal generator 218 emits electromagnetic radiation within its respective frequency range as defined by the corresponding channel weights 508.

The receiving device 104 detects transmitted electromagnetic radiation using the plurality of electromagnetic signal detectors 302. The signal processing circuitry 312 determines observed channel weights 606 and generates the received data representations 314. The receiver architecture 300 includes the decoy recognition module 322, which identifies the non-data carrying signal state 904 based on predefined patterns stored in memory. The decoy recognition module 322 excludes the non-data carrying signal state 904 from reconstruction operations.

The reconstruction module 316 processes only valid multi-channel signal states 506 to reconstruct the plurality of uncorrelated data streams 210 and to decrypt the reconstructed information using the symmetric key encryption algorithm to recover the input data 318.

In certain embodiments, the decoy signalling arrangement 900 varies characteristics of the non-data carrying signal state 904 over time to prevent pattern learning by an interceptor. In other embodiments, the decoy signalling arrangement 900 adapts the insertion rate of the non-data carrying signal state 904 based on detected channel conditions or security policies.

FIG. 9 demonstrates that insertion of the non-data carrying signal state 904 increases uncertainty for an unauthorized receiver by introducing signal patterns that do not correspond to actual encrypted data. Other embodiments may employ additional categories of decoy signal states, dynamic insertion schedules, or coordinated transmitter and receiver policies while remaining consistent with the decoy signalling arrangement 900 and the claims.

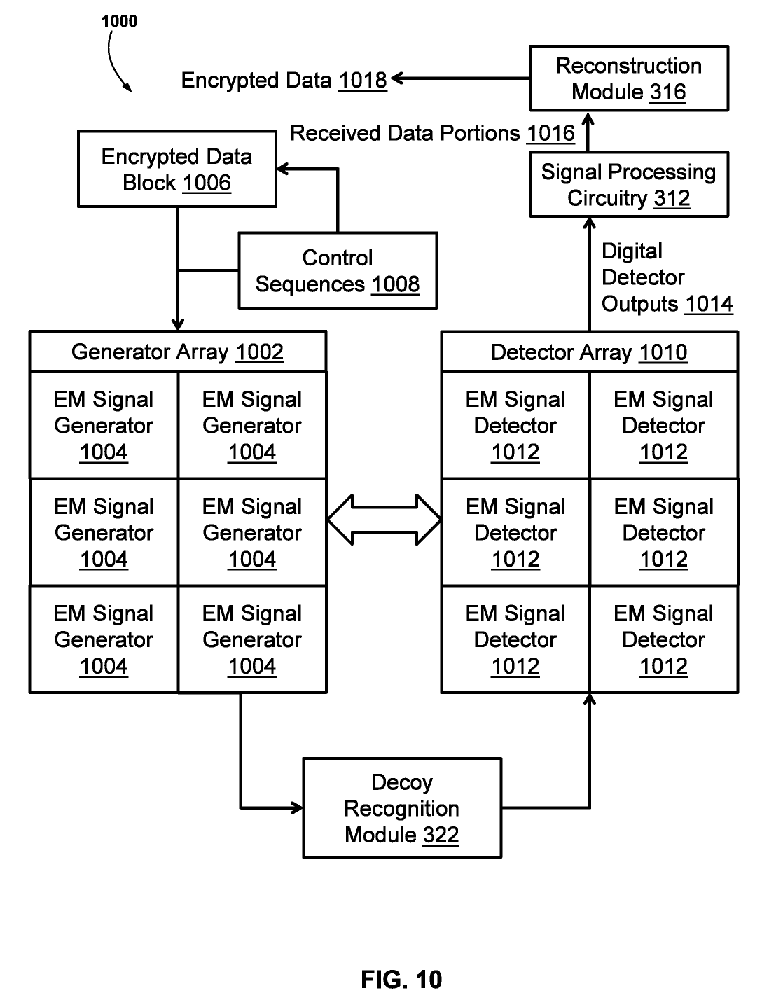

FIG. 10 illustrates an array implementation 1000 of the secure electromagnetic communication system 101 shown in FIG. 1. The array implementation 1000 shows how multiple electromagnetic signal generators and multiple electromagnetic signal detectors operate in parallel to transmit encrypted data blocks across distinct frequency ranges.

The array implementation 1000 includes a generator array 1002 positioned within the transmitting device 102. The generator array 1002 includes a plurality of electromagnetic signal generators 1004 arranged in a two-dimensional layout. Each electromagnetic signal generator 1004 corresponds to one channel of transmission and emits electromagnetic radiation within a respective frequency range. The respective frequency ranges differ from frequency ranges assigned to other electromagnetic signal generators 1004 within the generator array 1002.

The transmitting device 102 includes the at least one processor 202 and the non-transitory memory 204 described with reference to FIG. 2. The at least one processor 202 encrypts the input data 206 to generate encrypted data 208 and organizes the encrypted data 208 into encrypted data blocks 1006. Each encrypted data block 1006 includes multiple portions that the at least one processor 202 assigns to different channels of the generator array 1002.

The control sequence generation module 212 generates a set of control sequences 1008 corresponding to the encrypted data blocks 1006. Each control sequence 1008 defines emission parameters for a respective electromagnetic signal generator 1004. The drive circuitry 216 distributes the control sequences 1008 across the generator array 1002 so that multiple electromagnetic signal generators 1004 emit electromagnetic radiation in parallel during a common transmission interval.

In one embodiment, the generator array 1002 includes light emitting diodes arranged in rows and columns. Each row may correspond to a distinct frequency range, and each column may correspond to a different portion of an encrypted data block 1006. In another embodiment, the generator array 1002 includes radio frequency emitters configured to operate at separated carrier frequencies.

Electromagnetic radiation produced by the generator array 1002 propagates through the electromagnetic transmission medium 106 toward a detector array 1010 located within the receiving device 104. The detector array 1010 includes a plurality of electromagnetic signal detectors 1012 arranged in a layout that corresponds to the arrangement of the generator array 1002. Each electromagnetic signal detector 1012 detects electromagnetic radiation within a respective frequency range associated with a corresponding electromagnetic signal generator 1004.

The receiving device 104 includes the signal conditioning circuitry 306 and the analog to digital converter 308 that process outputs of the detector array 1010 to produce digital detector outputs 1014. The signal processing circuitry 312 analyzes the digital detector outputs 1014 to generate received data portions 1016 that correspond to the encrypted data blocks 1006 transmitted by the transmitting device 102.

The reconstruction module 316 combines the received data portions 1016 across parallel channels to reconstruct encrypted data 1018. The reconstruction module 316 decrypts the encrypted data 1018 using the symmetric key encryption algorithm to recover transmitted data 318 corresponding to the input data 206.

In certain embodiments, the array implementation 1000 increases throughput by transmitting multiple multi-channel signal states 506 simultaneously across the generator array 1002. In other embodiments, the array implementation 1000 provides redundancy by transmitting selected portions of encrypted data blocks 1006 across multiple electromagnetic signal generators 1004 to improve reliability under noisy channel conditions.

In further embodiments, the transmitting device 102 dynamically activates a subset of electromagnetic signal generators 1004 within the generator array 1002 based on available bandwidth, power constraints, or security policies. The receiving device 104 correspondingly selects a subset of electromagnetic signal detectors 1012 for processing.

FIG. 10 demonstrates that the array implementation 1000 enables parallel transmission of encrypted data blocks 1006 using multiple electromagnetic signal generators 1004 and corresponding electromagnetic signal detectors 1012. The parallel architecture increases data rate, enhances robustness, and maintains separation across distinct frequency ranges. Other embodiments may employ different array geometries, scalable channel counts, or distributed transmitter and receiver units while remaining consistent with the array implementation 1000 and the claims.

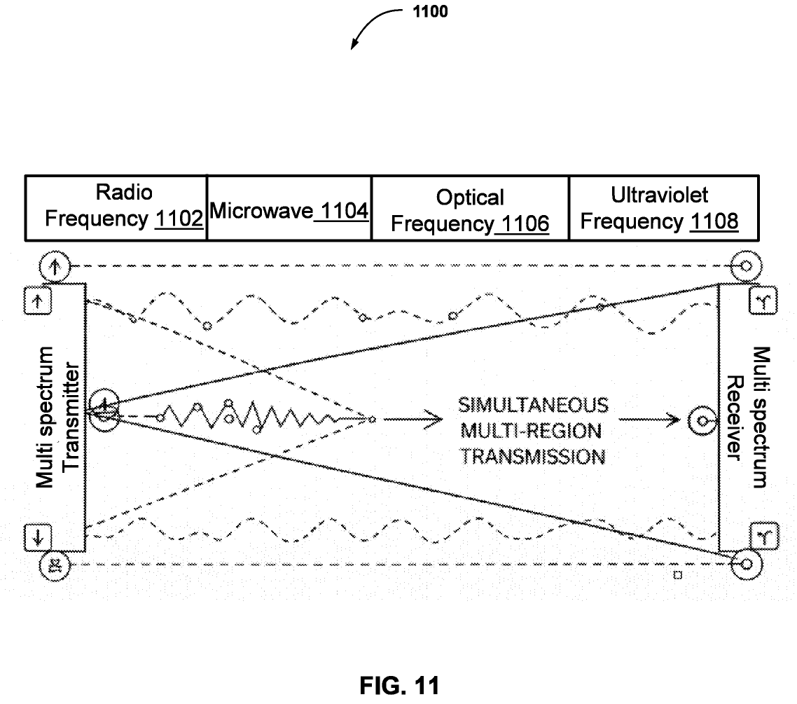

FIG. 11 illustrates spectrum deployment arrangement 1100 for the secure electromagnetic communication system 101 shown in FIG. 1. The spectrum deployment arrangement 1100 shows example implementations that operate across different portions of the electromagnetic spectrum while maintaining use of multiple signal channels that occupy distinct frequency ranges.

The spectrum deployment arrangement 1100 includes a first spectrum region 1102, a second spectrum region 1104, a third spectrum region 1106, and a fourth spectrum region 1108. Each spectrum region represents a portion of the electromagnetic spectrum within which the transmitting device 102 and the receiving device 104 may operate the plurality of electromagnetic signal generators 218 and the plurality of electromagnetic signal detectors 302.

In one embodiment, the first spectrum region 1102 corresponds to a radio frequency portion of the electromagnetic spectrum. In this embodiment, the plurality of electromagnetic signal generators 218 includes radio frequency oscillators configured to emit signals at separated carrier frequencies. The plurality of electromagnetic signal detectors 302 includes radio frequency receivers with band limiting circuitry that detects emissions within assigned frequency ranges.

In another embodiment, the second spectrum region 1104 corresponds to a microwave portion of the electromagnetic spectrum. The transmitting device 102 may employ microwave emitters such as controlled oscillators or antenna-based radiators. The receiving device 104 may employ microwave receivers configured to detect emissions within distinct microwave frequency bands.

In a further embodiment, the third spectrum region 1106 corresponds to an optical portion of the electromagnetic spectrum that includes visible or infrared wavelengths. The plurality of electromagnetic signal generators 218 may include light emitting diodes or laser sources configured to emit different wavelengths. The plurality of electromagnetic signal detectors 302 may include photodiodes combined with optical filters that isolate assigned wavelength ranges.

In another embodiment, the fourth spectrum region 1108 corresponds to an ultraviolet portion of the electromagnetic spectrum. The transmitting device 102 may include ultraviolet emitters, and the receiving device 104 may include ultraviolet sensitive detectors configured to detect emissions within separated ultraviolet frequency ranges.

The spectrum deployment arrangement 1100 supports operation of the secure electromagnetic communication system 101 within a single spectrum region or across multiple spectrum regions simultaneously. In one example, the transmitting device 102 assigns a first data stream of the plurality of uncorrelated data streams 210 to a radio frequency range and assigns a second data stream to an optical frequency range. In another example, the transmitting device 102 distributes portions of encrypted data 208 across several optical wavelength bands within the third spectrum region 1106.

The control sequence generation module 212 and the drive circuitry 216 operate in the same manner across the different spectrum regions by generating control sequences 214 and by controlling emission characteristics of the plurality of electromagnetic signal generators 218. The receiving device 104 processes detected signals using the plurality of electromagnetic signal detectors 302, the signal conditioning circuitry 306, the analog to digital converter 308, and the signal processing circuitry 312 to generate received data representations 314.

The reconstruction module 316 combines the received data representations 314 and decrypts the combined information using the symmetric key encryption algorithm to recover the input data 318 regardless of the spectrum region selected for transmission.

In certain embodiments, the secure electromagnetic communication system 101 dynamically selects one or more spectrum regions based on channel congestion, interference levels, regulatory constraints, or security policies. In other embodiments, the system uses simultaneous transmission across multiple spectrum regions to increase separation between channels and to reduce probability of interception.

FIG. 11 demonstrates that the secure electromagnetic communication system 101 operates across different portions of the electromagnetic spectrum while maintaining use of distinct frequency ranges for separate data streams. Other embodiments may include additional spectrum regions, hybrid optical and radio configurations, or environment specific spectrum selections while remaining consistent with the spectrum deployment arrangement 1100 and the claims.

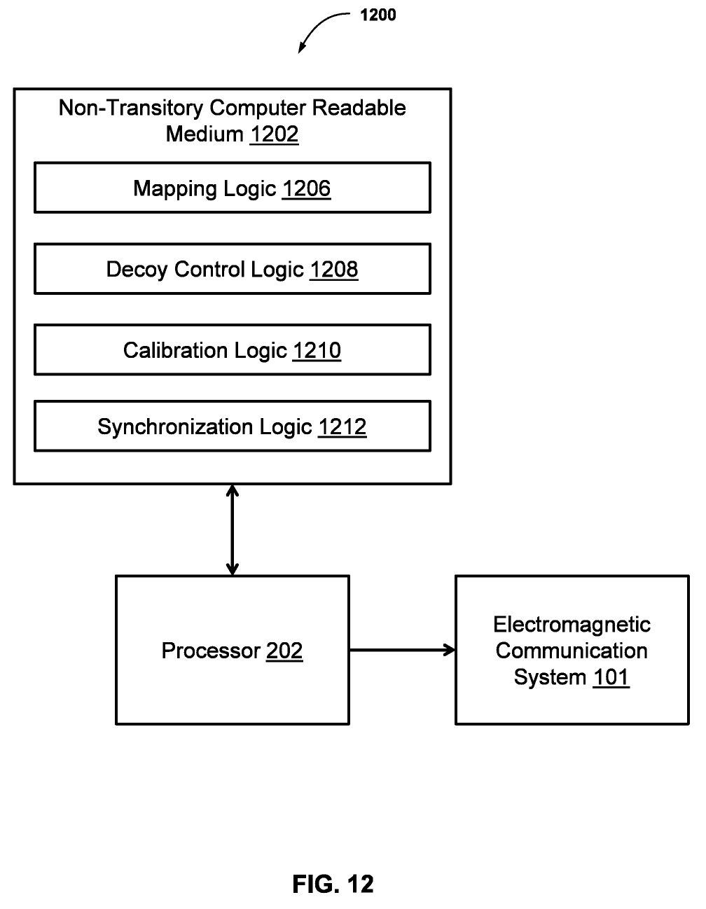

FIG. 12 illustrates a computer readable medium arrangement 1200 that supports operation of the secure electromagnetic communication system 101 shown in FIG. 1. The computer readable medium arrangement 1200 shows how stored instructions control encryption, signal generation, signal detection processing, and reconstruction functions executed by processing hardware within the transmitting device 102 and the receiving device 104.

The computer readable medium arrangement 1200 includes a non-transitory computer readable medium 1202. The non transitory computer readable medium 1202 stores executable instructions. In one embodiment, the non-transitory computer readable medium 1202 comprises semiconductor memory. In another embodiment, the non-transitory computer readable medium 1202 comprises magnetic storage or optical storage. In further embodiments, the non-transitory computer readable medium 1202 comprises a combination of storage technologies.

The executable instructions configure the at least one processor 202 to perform encryption of the input data 206 using the symmetric key encryption algorithm to generate encrypted data 208. The executable instructions further configure the at least one processor 202 to divide the encrypted data 208 into the plurality of uncorrelated data streams 210.

The executable instructions also configure the control sequence generation module 212 to generate the respective control sequences 214 for the plurality of electromagnetic signal generators 218. In one embodiment, the executable instructions include mapping logic 1206 that maps encrypted bits to multi-channel signal states 506 defined by channel weights 508. The mapping logic 1206 may reference a lookup table stored within the non-transitory computer readable medium 1202.

The executable instructions further configure the drive circuitry 216 to control emission timing, duration, or intensity of the plurality of electromagnetic signal generators 218 within their respective distinct frequency ranges. The executable instructions may also include decoy control logic 1208 that inserts non data carrying signal states 510 into transmitted sequences based on patterns derived from the symmetric key.

The computer readable medium arrangement 1200 also supports receiver side operations. The executable instructions configure the signal conditioning circuitry 306, the analog to digital converter 308, and the signal processing circuitry 312 to process outputs of the plurality of electromagnetic signal detectors 302 and to generate the received data representations 314.

The executable instructions further configure the reconstruction module 316 to combine the received data representations 314 and to decrypt the combined information using the symmetric key encryption algorithm to generate recovered data 318 corresponding to the input data 206.

In certain embodiments, the executable instructions include calibration logic 1210 that directs the transmitting device 102 to transmit known signal combinations 704 and directs the receiving device 104 to establish detection thresholds 712 for the plurality of electromagnetic signal detectors 302. In other embodiments, the executable instructions include synchronization logic 1212 that aligns timing between the transmitting device 102 and the receiving device 104 based on synchronization markers embedded within transmitted signals.

The non transitory computer readable medium 1202 may reside within the transmitting device 102, within the receiving device 104, or within both devices. In distributed implementations, portions of the executable instructions may execute on separate processing units that coordinate the operation of the secure electromagnetic communication system 101.

FIG. 12 demonstrates that the non-transitory computer readable medium 1202 stores executable instructions that direct operation of encryption, data stream partitioning, control sequence generation, electromagnetic signal transmission, signal detection processing, calibration, and reconstruction functions. Other embodiments may organize the executable instructions into separate software modules, firmware components, or programmable logic while remaining consistent with the computer readable medium arrangement 1200 and the claims.

The present invention provides significant advantages by implementing a secure communication architecture that integrates encryption with physical layer separation across multiple electromagnetic signal channels operating at distinct frequency ranges. By dividing encrypted data into a plurality of uncorrelated data streams and transmitting the data streams through separate electromagnetic emissions, the system reduces the information content available from any single intercepted channel. This distribution increases resistance to interception, traffic analysis, and selective jamming while maintaining compatibility with a wide range of electromagnetic implementations, including optical and radio frequency domains. The use of multi-channel signal states defined by channel weights further obscures direct relationships between transmitted signals and underlying data, thereby strengthening confidentiality without requiring replacement of established symmetric key encryption techniques.

The invention also improves reliability and adaptability of secure data transmission. Calibration operations establish detection thresholds for electromagnetic signal detectors, which enhances accurate recovery of transmitted information under varying environmental conditions and noise levels. Optional insertion of non data carrying signal states increases uncertainty for unauthorized receivers and reduces effectiveness of signal pattern analysis. Array based implementations enable parallel transmission of encrypted data blocks to increase throughput while preserving separation across distinct frequency ranges. These features collectively provide a flexible and scalable communication framework that enhances security at both cryptographic and physical transmission layers.

Although particular embodiments of the invention have been described in detail for purposes of illustration, various modifications and enhancements may be made without departing from the spirit and scope of the invention.

What is claimed is:

1. A secure electromagnetic communication system, comprising:
at least one processor;
a non-transitory memory storing instructions that, when executed by the at least one processor, cause the at least one processor to encrypt input data using a symmetric key encryption algorithm to generate encrypted data and to split the encrypted data into a plurality of uncorrelated data streams;
a plurality of electromagnetic signal generators, each electromagnetic signal generator being configured to emit electromagnetic radiation within a respective frequency range that is distinct from frequency ranges of remaining electromagnetic signal generators of the plurality of electromagnetic signal generators;
a drive circuitry configured to control each electromagnetic signal generator according to a respective control sequence derived from a corresponding one of the plurality of uncorrelated data streams;
a plurality of electromagnetic signal detectors, each electromagnetic signal detector being configured to detect electromagnetic radiation within a respective one of the distinct frequency ranges; and
a reconstruction module configured to recover the input data by processing outputs of the plurality of electromagnetic signal detectors and decrypting the processed outputs using the symmetric key encryption algorithm.

2. The secure electromagnetic communication system of claim 1, wherein the plurality of electromagnetic signal generators comprises at least one of light-emitting diodes, lasers, and voltage-controlled oscillators.

3. The secure electromagnetic communication system of claim 1, wherein the plurality of electromagnetic signal detectors comprises photodiodes.

4. The secure electromagnetic communication system of claim 1, further comprising at least one optical filter associated with at least one electromagnetic signal detector and configured to attenuate electromagnetic radiation outside the respective frequency range.

5. The secure electromagnetic communication system of claim 1, further comprising at least one waveguide configured to guide electromagnetic radiation from at least one electromagnetic signal generator toward a corresponding electromagnetic signal detector.

6. The secure electromagnetic communication system of claim 1, wherein the drive circuitry is configured to modulate at least one of duration, intensity, frequency, and polarization of emitted electromagnetic radiation to encode the respective control sequences.

7. The secure electromagnetic communication system of claim 1, wherein generating the respective control sequence comprises mapping bits of a corresponding data stream to a plurality of channel weights that collectively define a multi-channel signal state.

8. The secure electromagnetic communication system of claim 7, wherein the plurality of channel weights comprises a triplet of integer values that specify respective HIGH-state durations for three electromagnetic signal generators during a bit period.

9. The secure electromagnetic communication system of claim 7, wherein the reconstruction module is configured to ignore at least one predefined multi-channel signal state that represents a non-data-carrying decoy.

10. The secure electromagnetic communication system of claim 1, wherein the symmetric key encryption algorithm comprises a wave-based encryption algorithm that uses at least one electromagnetic frequency associated with at least one electromagnetic signal generator as part of a symmetric key.

11. A method for secure electromagnetic communication, comprising:
encrypting input data using a symmetric key encryption algorithm executed by at least one processor to generate encrypted data;
splitting the encrypted data into a plurality of uncorrelated data streams;
generating, for each data stream, a respective control sequence;
transmitting the plurality of data streams by driving a plurality of electromagnetic signal generators according to the respective control sequences, each electromagnetic signal generator transmitting within a distinct frequency range;
detecting the transmitted electromagnetic radiation using a plurality of electromagnetic signal detectors corresponding to the distinct frequency ranges; and
recovering the input data by decrypting information derived from outputs of the plurality of electromagnetic signal detectors using the symmetric key encryption algorithm.

12. The method of claim 11, wherein generating the respective control sequence comprises mapping each bit to a plurality of channel weights defining a multi-channel signal state.

13. The method of claim 12, wherein each multi-channel signal state comprises a triplet of integer weights corresponding to HIGH-state durations of three electromagnetic signal generators.

14. The method of claim 11, further comprising filtering detected electromagnetic radiation to attenuate frequencies outside the distinct frequency ranges.

15. The method of claim 11, further comprising calibrating the plurality of electromagnetic signal detectors by transmitting known signal combinations and establishing detection thresholds based on detector responses.

16. The method of claim 11, further comprising inserting non-data-carrying decoy signal states into an encrypted transmission.

17. A non-transitory computer-readable medium storing instructions that, when executed by at least one processor of a secure electromagnetic communication system comprising a plurality of electromagnetic signal generators and a plurality of electromagnetic signal detectors, cause the at least one processor to:
encrypt input data using a symmetric key encryption algorithm to generate encrypted data;
split the encrypted data into a plurality of uncorrelated data streams;
generate respective control sequences for the plurality of electromagnetic signal generators;
control the plurality of electromagnetic signal generators according to the respective control sequences within distinct frequency ranges;
process detector outputs from the plurality of electromagnetic signal detectors; and
decrypt the processed detector outputs to recover the input data.

18. The non-transitory computer-readable medium of claim 17, wherein the instructions further cause the at least one processor to perform detector calibration using known signal combinations.

19. The non-transitory computer-readable medium of claim 17, wherein the instructions further cause the at least one processor to encode data using multi-channel signal states defined by channel weight triplets.

20. The non-transitory computer-readable medium of claim 17, wherein the symmetric key encryption algorithm comprises a wave-based encryption algorithm combined with a key-distribution algorithm.
